(19) United States
(12) Patent Application Publication
(10) Pub. No.: US 2004/0186258 A1
(43) Pub. Date: Sep. 23, 2004

(54) Crush stop

(76) Inventors: Jun Arai, Kanagawa (JP); Naruhiko Mashita, Kanagawa (JP); Yasushi Imai, Kanagawa (JP); Tsunehiro Yamamoto, Kanagawa (JP); Tadashi Utsunomiya, Kanagawa (JP); Tatsuhiko Hosokawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/477,324

(22) PCT Filed: Jan. 28, 2002
(86) PCT No.: PCT/JP02/00594

(30) Foreign Application Priority Data
May 16, 2001 (JP) 2001-146288

(51) Int. Cl. C08F 12/02

(52) U.S. Cl. 526/346

(57) ABSTRACT

A crush stop comprising a thermoplastic elastomer composition which has a hardness as measured with a hardness tester type A in accordance with JIS-K-6253 being at least 50 degrees and which has dependence of elastic modulus upon temperature being at most 3 times between 0° C. and 60° C. The crush stop is minimized in the displacement due to impact of a stopper arm, and is excellent in impact absorbing properties over a wide range of temperatures.

### TECHNICAL FIELD

The present invention relates to a crush stop which regulates the swinging range of an actuator for a magnetic disc unit. More particularly, it pertains to a crush stop which is minimized in the displacement due to impact of a stopper arm, and is excellent in impact absorbing properties over a wide range of temperatures.

### BACKGROUND ART

A magnetic disc unit is a unit which locates the position of a magnetic head installed at the tip of an actuator that constitutes a part of a positioning mechanism for a high velocity head and besides, records and reproduces magnetic signals on the magnetic disc by means of the above-mentioned magnetic head. The positioning of the magnetic head is put into practice by controlling the Lorentz force which is generated by a coil that is supported with a voice coil motor and an actuator through the control of electric current to be passed through the aforesaid coil.

The actuator is equipped in the vicinity thereof with a stopper mechanism termed crush stop which is intended to prevent a magnetic head and/or a head gimbal assembly from colliding with another member, falling out or being damaged in the event that a head positioning mechanism becomes uncontrollable and runaway by reason of malfunctioning or the like.

There has heretofore been prevalently employed as the above-mentioned crush stop, an elastic body composed of a thermoplastic elastomer of any of polyurethane base and polyvinyl chloride base. However, the crush stop made of the above-mentioned elastic body involves such a problem that the swinging range of an actuator unfavorably varies because of a large displacement of the portion on which a stopper arm abuts and also a great variation in elastic modulus depending upon temperatures.

### DISCLOSURE OF THE INVENTION

An object of the present invention is to provide under such circumstances, a crush stop which is minimized in the displacement due to impact of a stopper arm, and is excellent in impact absorbing properties over a wide range of temperatures. As a result of intensive extensive research and investigation accumulated by the present inventors in order to achieve the above-mentioned objects, it has been found that said objects can be achieved by constituting a crush stop of a thermoplastic elastomer composition which has a specific hardness and also specific dependence of elastic modulus upon temperature. Thus the present invention has been accomplished on the basis of the foregoing findings and information.

That is to say, the present invention provides a crush stop comprising a thermoplastic elastomer composition which has a hardness as measured with a hardness tester type A in accordance with JIS-K-6253 being at least 50 degrees and which has dependence of elastic modulus upon temperature being at most 3 times between 0° C. and 60° C.

### THE MOST PREFERRED EMBODIMENT TO CARRY OUT THE INVENTION

It is indispensable that the thermoplastic elastomer composition which is used in the present invention has a hardness as measured with a hardness tester A type A in accordance with JIS-K-6253 (hereinafter simply referred to as Hardness) being at least 50 degrees, preferably at least 70 degrees, more preferably at least 80 degrees and which has dependence of elastic modulus upon temperature being at most 3 times, preferably at most 2.5 times, more preferably at most 2.0 times each between 0° C. and 60° C.

The Hardness, when being less than 50 degrees, brings about an unreasonably large displacement at the portion where a stopper arm abuts thereon. In addition, the dependence of elastic modulus upon temperature, when exceeding 3 times between 0° C. and 60° C., gives rise to a great variation in elastic modulus depending upon the working temperature with the result that the swinging range of an actuator unfavorably varies, thereby making it impossible to sufficiently fulfill the function as a crush stop.

The thermoplastic elastomer composition which has such specific properties as mentioned hereinbefore is obtainable by the use of, for instance, a thermoplastic elastomer composition which is composed, as a polymer component, of at least one species selected from styrenic polymers such as polystyrene and styrenic block copolymers; olefinic polymers such as polyethylene and polypropylene; polyester based polymers such as polyethylene terephthalate and polybutylene terephthalate; and polyamide based polymers such as polyamide.

Among the polymer components as mentioned above, there are preferably used in particular, a thermoplastic elastomer composed, as polymer components, of at least one polymer block containing a vinyl aromatic compound as a principal component and at least one polymer block containing a conjugated diene compound as a principal component and a thermoplastic elastomer composed, as polymer components, of polyester based polymers such as polybutylene terephthalate. More specific examples of the thermoplastic elastomer include a block copolymer of crystalline polyethylene and ethylene/butylene-styrene random copolymer, said polyethylene being produced by hydrogenating a block copolymer of polybutadiene and butadiene-styrene random copolymer; a diblock copolymer of crystalline polyethylene and polystyrene; a triblock copolymer of styrene-ethylene/butylene-styrene (SEBS); a triblock copolymer of styrene-ethylene/propylene-styrene (SEPS); especially block copolymer of styrene-ethylene/butylene-styrene; block copolymer of styrene-ethylene/propylene-styrene, each being produced by hydrogenating a block copolymer of polybutadiene and polystyrene and a block copolymer of polyisoprene and polystyrene or a block copolymer of polybutadiene or ethylene-butadiene random copolymer and polystyrene. Any of the above-exemplified thermoplastic elastomers may be used alone or in combination with at least one other species. Nevertheless as described hereinabove, the use of a thermoplastic elastomer of any of polyurethane base and polyvinyl chloride base makes it impossible to obtain a thermoplastic elastomer composition which is imparted with desirable physical properties in particular, specific dependence of elastic modulus upon temperature. In addition, the thermoplastic elastomer composition to be used in the present invention is required to have such physical properties as moderately absorbing impact energy of a stopper arm and at the same time, durability against repeated impact thereof. Moreover it is desirable that the thermoplastic elastomer composition has a rebound resilience factor as determined in accordance with ASTM-D6301 being in the range of 40 to 90% in particular, 50 to 85% and also compression set as determined at 70° C. after 22 hours in accordance with ASTM-D6301 being at most 70% in particular, at most 50%.

The thermoplastic elastomer composition to be used in the present invention may be blended as desired, with polyphenylene ether resin for the purpose of improving the compression set thereof, set the same within the above-mentioned range and the like. The polyphenylene ether resin to be used therefor may be selected for use from publicly well known ones, and is specifically exemplified by poly(2,6-dimethyl-1,4-phenylene ether); poly(2-methyl-6-ethyl-1,4-phenylene ether); poly(2,6-diphenyl-1,4-phenylene ether); poly(2-methyl-6-phenyl-1,4-phenylene ether); and poly(2,6-dichloro-1,4-phenylene ether). There is also usable a polyphenylene ether copolymer such as the copolymer of 2, 6-dimethylphenol and a monohydric phenols (e.g. 2,3,6-trimethylphenol and 2-methyl-6-butylphenol). Of these are preferable poly(2,6-dimethyl-1,4-phenylene ether) and the copolymer of 2,6-dimethylphenol and 2,3,6-trimethylphenol, and poly(2,6-dimethyl-1,4-phenylene ether) is preferable in particular.

In addition thereto, inasmuch as a variety of physical properties as described above are maintained, the thermoplastic elastomer composition to be used in present invention may be blended as desired, with a flaky inorganic additive such as clay, diatomaceous earth, silica, talc, barium sulfate, calcium carbonate, magnesium carbonate, a metal oxide, mica, graphite and aluminum hydroxide, various metal powders, glass powder, ceramics powder, granular or powdery solid filler such as granular or powdery polymer, and a variety of natural or artificial short fibers and long fibers (such as glass fiber, metallic fiber and a variety of polymer fibers).

It is possible at need to use simultaneously with the composition, such additive as flame retardants, antimicrobial agents, hindered amine base light stabilizer, ultraviolet rays absorbers, antioxidants and colorants.

The process for producing the thermoplastic elastomer composition to be used in he present invention is not specifically limited, but well known processes are applicable thereto. For example, the thermoplastic elastomer composition is readily producible by a process which comprises the steps of melt kneading the above-mentioned thermoplastic elastomer and the additive components to be used as desired by the use of a heating kneader such as a single screw extruder, a twin screw extruder, a roll, a Banbury mixer, a Brabender, a kneader and a high shear type mixer; further adding as desired to the resultant mixture, a cross-linking agent such as an organic peroxide, a cross-linking aid or the like, or simultaneously mixing with the necessary components; and melt kneading by heating the resultant mixture.

Further, the thermoplastic elastomer composition to be used in the present invention can be cross-linked by adding thereto, a cross-linking agent, a cross-linking aid and the like.

The thermoplastic elastomer composition obtained in the aforesaid manner can be put into use as a crush stop by molding the same through a publicly well known method including injection molding, extrusion molding and the like.

The crush stop thus produced according to the present invention is minimized in the displacement due to impact of a stopper arm, and is excellent in impact absorbing properties over a wide range of temperatures.

In what follows, the present invention will be described in more detail with reference to working examples, which however shall never limit the present invention thereto.

### EXAMPLES 1 TO 3 AND COMPARATIVE EXAMPLES 1 AND 2

Crush stops were prepared each by means of injection molding from the thermoplastic elastomer compositions comprising the polymer components (unit: parts by weight) as given in Table 1, which indicates a variety of physical properties of the thermoplastic elastomer compositions thus obtained and the evaluation results of the resultant crush stops.

The evaluation of the crush stops thus obtained was carried out in such a manner that they were each placed inside a magnetic disc unit, the head positioning mechanism was allowed to run away in an atmosphere of 0 to 60° C., any damage to the above-mentioned crush stop was confirmed, and the crush stops were evaluated in accordance with the criterion as shown hereunder.

TABLE 1

| | | | | | | | | | Rebound | | |
|---|---|---|---|---|---|---|---|---|---|---|---|
| | Polymer components in the | | | | | | | Elastic | resilience | Compression | |
| | composition (part by weight) | | | | | | Hardness | modulus | factor | set | |
| | PTB | SEBS | PP | PS | TPU | PVC | (A) | (0□/60□) | (%) | (%) | Evaluation |
| Example | | | | | | | | | | | |
| 1 | 100 | | | | | | 80 | 1.2 | 80 | 50 | A |
| 2 | | 100 | 20 | | | | 70 | 1.3 | 50 | 60 | A |
| 3 | | | 100 | 100 | | | 85 | 1.3 | 60 | 60 | A |
| Comparative | | | | | | | | | | | |
| Example | | | | | | | | | | | |
| 1 | | | | | 100 | | 80 | 2.5 | 80 | 50 | B |
| 2 | | | | | | 100 | 65 | 3.5 | 30 | 80 | B |

Evaluation:
A: no damage to crush stop observed between 0° C. and 60° C.
B: damage to crush stop observed between 0° C. and 60° C.
The symbols for polymer components in the thermoplastic elastomer composition used in Table 1 are detailed in the following:
PBT; polybutylene terephthalate (manufactured by Toyobo Co., Ltd., under the trade name “Belbrene”)
SEBS; styrene-ethylene/butylene-styrene block copolymer (manufactured by Asahi Chemical Industry Co., Ltd., under the trade name “Tuftec”)
PP; polypropylene (manufactured by Sumitomo Chemical Industry Co., Ltd., under the trade name “Noubrene”)
PS; polystyrene (manufactured by Asahi Chemical Industry Co., Ltd., under the trade name “Styron”)
TPU; thermoplastic polyurethane (manufactured by Kuraray Co., Ltd., under the trade name “Miraclon”)
PVC; polyvinyl chloride (manufactured by Shin-Etsu Chemical Co., Ltd.)
Measurements were made of the physical properties of the resultant thermoplastic elastomer composition in the following manner:
Hardness; measured in accordance with JIS-K-6253 by the use of a hardness tester type A.
Elastic modulus; measured at 0° C. and 60° C. in accordance with JIS-K-6253, and dependence of elastic modulus upon temperature was judged from the ratio of elastic modulus at 0° C. to that at 60° C.
Rebound resilience factor; measured in accordance with ASTM-D6301
Compression set; strain at 70° C. after 22 hours was measured in accordance with ASTM-D6301.

### INDUSTRIAL APPLICABILITY

The crush stop produced according to the present invention is minimized in the displacement due to impact of a stopper arm, and is excellent in impact absorbing properties over a wide range of temperatures.

1. A crush stop comprising a thermoplastic elastomer composition which has a hardness as measured with a hardness tester type A in accordance with JIS-K-6253 being at least 50 degrees and which has dependence of elastic modulus upon temperature being at most 3 times between 0° C. and 60° C.

2. The crush stop according to claim 1 wherein the thermoplastic elastomer composition has a rebound resilience factor as determined in accordance with ASTM-D6301 being in the range of 40 to 90% and has a compression set as determined at 70° C. after 22 hours in accordance with ASTM-D6301 being at most 70%.

3. The crush stop according to claim 1 or 2 wherein the thermoplastic elastomer composition is that which comprises as polymer components, at least one polymer selected from the group consisting of a styrenic polymer, an olefinic polymer, a polyester base polymer and a polyamide base polymer.

4. The crush stop according to claim 3 wherein the styrenic polymer is polystyrene or a styrene base block copolymer.

5. The crush stop according to claim 3 wherein the olefinic polymer comprises polyethylene or polypropylene as a principal component.

6. The crush stop according to claim 3 wherein the polyester base polymer comprises polybutylene terephthalate as a principal component.

7. The crush stop according to claim 3 wherein the polyamide base polymer comprises polyamide as a principal component.
